(19) United States
(12) Patent Application Publication
(10) Pub. No.: US 2013/0057825 A1
(43) Pub. Date: Mar. 7, 2013

(54) Progressive-Power Lens Selector, Progressive Power Lens Selection Method, and Non-Transitory Computer Readable Storage Medium Storing A Progressive-Power Lens Selection Program

(71) Applicant: Kazutoshi KATO, Minamiminowa-mura (JP)

(72) Inventor: Kazutoshi KATO, Minamiminowa-mura (JP)

(73) Assignee: SEIKO EPSON CORPORATION, Tokyo (JP)

(21) Appl. No.: 13/599,903

(22) Filed: Aug. 30, 2012

(30) Foreign Application Priority Data
Sep. 2, 2011 (JP) 2011-192045

(51) Int. Cl. G02C 7/06

(52) U.S. Cl. 351/159.42

(57) ABSTRACT

An accommodation ability acquisition unit, a near vision prescription range acquisition unit, a lens database storing design parameters of progressive-power lenses in response to addition power with respect to each of plural types, an accommodation ability computation unit computing used accommodation ability for near vision, a necessary addition power computation unit computing necessary addition power for near vision, a range computation unit computing the maximum distance ranges and the maximum near ranges when lenses are worn based on the necessary addition power in lenses selected as lenses having design elements of a set condition equal to or more than the necessary addition power of the plural types stored in the lens database, and an output control unit allowing a display device to display the maximum distance ranges and the maximum near ranges with respect to the lenses of the design types selected by a selecting unit in juxtaposition are provided.

This application claims priority to Japanese Patent Application No. 2011-192045, filed September 2, the entirety of which is hereby incorporated by reference.

### BACKGROUND

1. Technical Field

The present invention relates to a progressive-power lens selector, a progressive-power lens selection method, and a non-transitory computer readable storage medium storing a progressive-power lens selection program.

2. Related Art

Spectacle lenses include progressive-power spectacle lenses in addition to single-focus spectacle lenses. The progressive-power spectacle lenses include not only bifocal types for continuously seeing both near and distance objects according to the intended use or the like but also the so-called middle-near vision types for exclusive use indoor and in-room for seeing objects within three to four meters to hands, and further, the so-called near-near vision types for seeing objects around hands.

The progressive-power lenses are designed according to conditions of individual wearers of optometry information of wearers, frame information, spectacle lens information, and so on. However, it is difficult for an examinee without a specialized knowledge to select appropriate corrective lenses and it is difficult for an examiner in an optician shop or ophthalmology department to adequately explain the differences in vision depending on various spectacle lenses to the examinee, and a system for facilitating selection of lenses is desired.

There is an example of a vision tester including input means for inputting data of dioptric power for distance vision correction and addition power of eyes to be examined obtained from subjective examination, display means that can display graphics, computing means for obtaining respective distance points and near points of eyes corrected by single-focal lenses for distance vision, single-focal lenses for near vision, and progressive-power lenses, and display control means for allowing the display means to display clear vision ranges by corrective lenses based on the distance points and the near points obtained by the computing means in graphic representation (Japanese patent application JP-A-2009-95635). In JP-A-2009-95635, when the data of addition power is switched, the clear vision range of the switched addition power is displayed.

In JP-A-2009-95635, fields of depth vision (clear vision ranges) are also displayed in consideration of accommodation ability of eyes. However, one pattern of the field of depth vision is displayed for each addition power, and, when plural spectacle lenses are selected, it is necessary to switch display, and it is difficult to select spectacle lenses if the display is switched.

### SUMMARY

An advantage of some aspects of the invention is to provide a progressive-power lens selector, a progressive-power lens selection method, and a progressive-power lens selection program that may appropriately determine a field of depth vision and easily select an appropriate progressive-power lens.

An aspect of the invention is directed to a progressive-power lens selector, including an accommodation ability acquisition unit that acquires accommodation ability data as a range that may be clearly seen by an eye of a wearer, a near vision prescription range acquisition unit that acquires near vision prescription range data as a range the wearer desires to clearly see using a near portion of the progressive power lens, a storage unit that stores design parameters of the progressive-power lens in response to different addition power with respect to each of plural types, an accommodation ability computation unit that computes used accommodation ability for near vision based on the accommodation ability data, a necessary addition power computation unit that computes necessary addition power for near vision based on the near vision prescription range data, a range computation unit that selects types having addition power equal to or more than the necessary addition power of the plural types stored in the storage unit and computes the maximum distance ranges and the maximum near ranges when the lenses of the selected types are worn based on the necessary addition power, and an output control unit that allows a display device to display clear vision ranges with respect to each lens of the selected types in juxtaposition based on the maximum distance ranges and the maximum near ranges.

Another aspect of the invention is directed to a progressive-power lens selection method, including acquiring accommodation ability data as a range that may be clearly seen by an eye of a wearer, acquiring near vision prescription range data as a range the wearer desires to clearly see using a near portion of the progressive power lens, computing used accommodation ability for near vision based on the accommodation ability data, computing necessary addition power for near vision based on the near vision prescription range data, selecting types having addition power equal to or more than the necessary addition power from a storage unit that stores design parameters of the progressive-power lens in response to different addition power with respect to each of plural types, computing the maximum distance ranges and the maximum near ranges when the lenses are worn based on the necessary addition power, and allowing a display device to display clear vision ranges with respect to each lens of the selected types in juxtaposition based on the maximum distance ranges and the maximum near ranges.

Still another aspect of the invention is directed to a non-transitory computer readable storage medium storing a progressive-power lens selection program, the program allows a computer to realize acquiring accommodation ability data as a range that may be clearly seen by an eye of a wearer, acquiring near vision prescription range data as a range the wearer desires to clearly see using a near portion of the progressive-power lens, computing used accommodation ability for near vision based on the accommodation ability data, computing necessary addition power for near vision based on the near vision prescription range data, selecting types having addition power equal to or more than the necessary addition power from a storage unit that stores design parameters of the progressive-power lens in response to different addition power with respect to each of plural types, computing the maximum distance ranges and the maximum near ranges when the lenses are worn based on the necessary addition power, and allowing a display device to display clear vision ranges with respect to each lens of the selected types in juxtaposition based on the maximum distance ranges and the maximum near ranges.

In the aspects of the invention having the configurations, the accommodation ability data is obtained by examination with respect to individual wearers. Further, the range that the wearer desires to clearly see (the range that the wearer desires to view) is determined depending on the individual wearers. For example, a range in which the wearer easily reads a book is determined as a near vision prescription range within a range of 30 cm from the eye.

Then, the used accommodation ability for near vision is computed based on the accommodation ability data, and the necessary addition power for near vision is computed based on the near vision prescription range data.

The design parameters of the progressive-power lenses (for example, distance design reference points, near design reference points, addition power, fitting points, etc.) are stored in response to addition power with respect to each of plural types, and the lenses of the types having addition power equal to or more than the necessary addition power are selected. The maximum distance ranges and the maximum near ranges when the lenses are worn are computed based on the computation results of the necessary addition power. Further, the clear vision ranges obtained using the maximum distance ranges and the maximum near ranges are displayed in juxtaposition with respect to each lens of the selected types in a display device, for example, a display of a personal computer. That is, in the display device, the clear vision ranges are displayed in the respective plural types of lenses in juxtaposition.

Therefore, in the aspects of the invention, the wearer sees the display of the clear vision ranges of the plural types of lenses in juxtaposition on the screen of the display device, and appropriately determines the field of depth vision from the types and selects an appropriate lens for himself or herself. Further, an examiner in an optician shop or ophthalmology department may smoothly make explanation to an examinee (wearer) while showing the screen of the display device to the examinee, and may select an appropriate progressive-power lens.

Here, it is preferable that the progressive-power lens selector according to the aspect of the invention further includes a line-of-sight position acquisition unit that acquires data of a line-of-sight position of the wearer in the progressive-power lens, a working range acquisition unit that acquires data of a working range of the wearer, a line-of-sight position addition power computation unit that computes addition power in the line-of-sight position based on the data of the line-of-sight position, a distance range computation unit that computes a distance range in the line-of-sight position based on the addition power in the line-of-sight position, and a determination unit that determines whether or not the distance range in the line-of-sight position falls within a range of the data of the working range, wherein the output control unit allows the display device to display a result determined in the determination unit.

In the aspect of the invention having the configuration described above, the data of the line-of-sight position is obtained by examining which position of the lens the individual wearer sees and determining the position as the line-of-sight position. Therefore, the data of the line-of-sight position is data representing the position on the lens. The data of the line-of-sight position is acquired, and similarly, the working range determined with respect to the individual wearer is acquired. In the line-of-sight position addition power computation unit, the addition power in the line-of-sight position is computed using the data of the line-of-sight position. In the distance range computation unit, the distance range in the line-of-sight position is computed based on the addition power in the line-of-sight position. Further, in the determination unit, the distance range in the line-of-sight position and the working range are compared, and, if the distance range in the line-of-sight position is equal to or more than the working range, determination that the clear vision may be obtained in the working range is made and the output control unit allows the display device to display that the clear vision may be obtained, for example, “OK”. On the other hand, if the distance range in the line-of-sight position is less than the working range, determination that the clear vision may not be obtained in the working range is made and the output control unit allows the display device to display that the clear vision may not be obtained, for example, “NG”.

Therefore, in the aspect of the invention, whether or not the depth clear vision range in the line-of-sight position is appropriate may be determined.

Further, in the aspect of the invention, it is preferable that the storage unit stores accommodation ability use rates for near vision, and the accommodation ability computation unit computes the used accommodation ability for near vision by multiplying the data of the accommodation ability by the accommodation ability use rate.

In the aspect of the invention having the configuration described above, the accommodation ability use rate for near vision is called from the storage unit and the used accommodation ability for near vision is computed in the accommodation ability computation unit. Generally, a half of the accommodation ability of the wearer is used and the deficiency in the dioptric power for near vision is often compensated by the lens, and thus, the accommodation ability use rate may be fixed to a numeric value of 0.5. The value may be changed depending on the individual wearers.

Therefore, in the aspect of the invention, the used accommodation ability is obtained in consideration of the use condition of the accommodation ability for near vision, and thus, the progressive-power lens may be more properly selected.

In the aspect of the invention, it is preferable that the output control unit allows the display device to display the maximum distance ranges and the maximum near ranges in graphic representation.

In the aspect of the invention having the configuration described above, the clear vision ranges are displayed in graphic representation in the respective lenses of plural types, and thus, the selection operation of the progressive-power lens may be more easily performed.

In the aspect of the invention, it is preferable that the output control unit allows the display device to display a distance in a depth direction of the clear vision range as a first axis and a width of the clear vision range in the line-of-sight position as a second axis orthogonal to the first axis.

In the aspect of the invention having the configuration described above, the widths of the clear vision ranges are also displayed, and thus, the differences in vision become more specific and the lens selection operation becomes easier.

In the aspect of the invention, it is preferable that the output control unit allows the display device to display the line-of-sight position along a third axis orthogonal to the first axis and orthogonal to the second axis.

In the aspect of the invention having the configuration described above, the clear vision ranges are three-dimensionally displayed with respect to each different line-of-sight position, and thus, the lens selection operation becomes easier.

### BRIEF DESCRIPTION OF THE DRAWINGS

The invention will be described with reference to the accompanying drawings, wherein like numbers reference like elements.

FIG. 1 is a block diagram showing a schematic configuration of a selector of a progressive-power lens according to a first embodiment of the invention.

FIG. 2A is a front view showing the progressive-power lens according to the first embodiment, and FIG. 2B is a graph showing a position A on the lens where a line of sight frequently passes when the lens is worn and a change of power in the position A.

FIG. 3 is a schematic diagram of a screen displayed in a display device.

FIG. 4 is a flowchart for explanation of a selection method of the progressive-power lens according to the first embodiment.

FIG. 5 is a diagram of a selector of a progressive-power lens according to a second embodiment of the invention, which corresponds to FIG. 3.

FIG. 6 shows a graph displayed in a display device of a selector of a progressive-power lens according to a third embodiment of the invention.

### DESCRIPTION OF EXEMPLARY EMBODIMENTS

Embodiments of the invention will be explained with reference to the drawings. Here, in the explanation of the respective embodiments, the same component elements have the same signs and their explanation will be omitted.

A progressive-power lens of the first embodiment is of the so-called middle-near vision type for exclusive use indoor and in-room for seeing objects within three to four meters to hands or the so-called near-near vision types for seeing objects around hands, and a near portion is provided in the type of progressive-power lens.

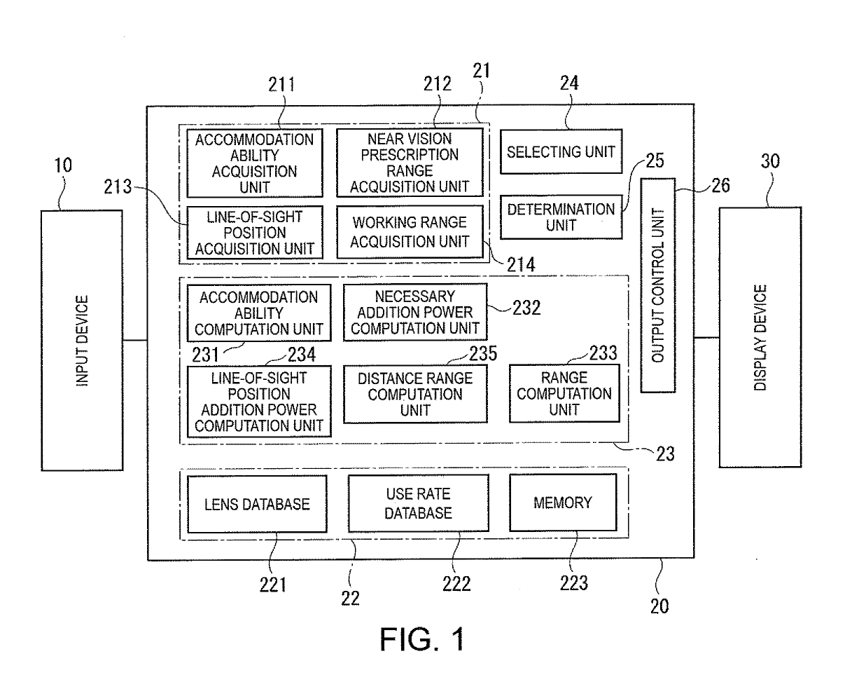

FIG. 1 is a block diagram showing a schematic configuration of a progressive-power lens selector of the embodiment.

In FIG. 1, the progressive-power lens selector is a personal computer including an input device 10, a processing device 20, and a display device 30.

The input device 10 includes a keyboard, a mouse, etc. accompanying the personal computer and has various operation buttons, operation knobs, and the like (not shown) for input operation. In place of the keyboard or the like, a touch panel may be used. The input device 10 may be a keyboard etc. of a personal computer that inputs data to the processing device 20 on a line of the Internet line or the like in place of the accompanying keyboard, or a vision tester from which data is input to the processing device 20 directly or via the internet line.

The display device 30 is a display device accompanying the personal computer, and image information etc. input from the processing device 20 is screen-displayed in a display area (not shown).

As the display device 30, for example, a liquid crystal panel, an organic EL (Electro Luminescence) panel, a PDP (Plasma Display Panel), a CRT (Cathode-Ray Tube), an FED (Field Emission Display), an electrophoretic display panel, and so on may be cited as examples.

The display device 30 may be a display device of a personal computer to which a signal is output from the processing device 20 on a line of the Internet line or the like.

The processing device 20 is a personal computer main body, for example, and includes a CPU, a memory, an HDD, etc. The processing device 20 includes a data acquiring unit 21 configured to acquire data from the input device 10, a storage unit 22 to which necessary data has been input from the input device 10 etc. in advance, a computing unit 23 configured to perform predetermined computation based on signals called from the data acquiring unit 21 and the storage unit 22, a selecting unit 24 configured to select data that fulfills a fixed condition among predetermined data stored in the storage unit 22, and an output control unit 26 that outputs a computation result by the computing unit 23 to the display device 30. The processing device 20 may include a determination unit 25 that determines whether or not the data meets a predetermined condition based on the result computed by the computing unit 23. Note that the data acquiring unit 21, the computing unit 23, the selecting unit 24, the determination unit 25, and the output control unit 26 may be realized by loading programs in a computer such as a personal computer.

The data acquiring unit 21 includes an accommodation ability acquisition unit 211 and a near vision prescription range acquisition unit 212. The data acquiring unit 21 may further include a line-of-sight position acquisition unit 213 and a working range acquisition unit 214. Various data is acquired by the data acquiring unit 21 through the input device 10.

The accommodation ability acquisition unit 211 acquires accommodation ability data of an eye as a range that the wearer can see with the eye (clear vision range). Here, the accommodation ability data of the eye is a value Amax of dioptric power (power) corresponding to the range that the wearer can see with the naked eye. The accommodation ability of the eye is measured by a vision tester or another device, and the value is different depending on the wearer.

The near vision prescription range acquisition unit 212 acquires near vision prescription range data as a range the wearer desires to see in the near portion. The near vision prescription range data is a range from an object that the wearer desires to see to the eye and, for example, when the wearer desires to see a book at hand, the range at 30 cm from the eye is a near vision prescription range and, when the wearer desires to see a personal computer, the range at 50 cm from the eye is a near vision prescription range.

The line-of-sight position acquisition unit 213 acquires line-of-sight position data of the wearer on the progressive-power lens. The line-of-sight position data refers to a position where the line of sight of the wearer passes on the line segment (principal meridian) on the lens, and is obtained with respect to each wearer by examination or the like.

The working range acquisition unit 214 acquires working range data of the wearer. The working range data refers to a range that the wearer sees most frequently, and is a numeric value obtained with respect to each wearer by examination or the like.

The storage unit 22 includes a lens database 221 and a memory 223. The storage unit 22 may include a use rate database 222.

In the lens database 221, design parameters of the progressive-power lenses, for example, distance design reference points, near design reference points, addition power, fitting points, etc. are readably stored in response to different addition power with respect to each of plural types. For example, with respect to each of type 1, type 2, type 3, type 4, type 5, etc., addition power, distance design reference points, near design reference points, etc. in response to the type are associated and stored.

In the use rate database 222, accommodation ability use rates ap for near vision are readably stored.

The accommodation ability use rate ap for near vision refers to a rate as to how much the accommodation ability of the wearer is used when the spectacle is worn. For example, in the case where a half of the accommodation ability of the wearer is used and deficiency in the dioptric power for near vision is compensated by the lens, the accommodation ability use rate ap is 0.5. The numeric value may be varied depending on the individual wearer, however, the value of 0.5 is a value often used in lens design and the value may be used as a prescribed value. Note that, when the accommodation ability used for near vision is input as the accommodation ability of the wearer, the accommodation ability use rate ap is 1.0.

In the memory 223, settings for input operation by the input device 10 are appropriately readably stored. Further, in the memory 223, various programs to be developed on the OS (Operating System) that operation-controls the entire selector and the like are stored. Note that the memory 223 may include a drive, a driver, etc. for readable storage in recording media such as an HD, a DVD, an optical disc, or the like.

The computing unit 23 includes an accommodation ability computation unit 231, a necessary addition power computation unit 232, and a range computation unit 233. The computing unit 23 may include a line-of-sight position addition power computation unit 234 and a distance range computation unit 235.

The accommodation ability computation unit 231 computes the used accommodation ability for near vision A based on A=Amax×ap from the accommodation ability data of the eye Amax acquired in the accommodation ability acquisition unit 211 and the accommodation ability use rate ap stored in the use rate database 222.

The necessary addition power computation unit 232 obtains lens necessary addition power C based on the near vision prescription range data Nd acquired in the near vision prescription range acquisition unit 212. That is, in the necessary addition power computation unit 232, on the basis of the near vision prescription range data Nd acquired in the near vision prescription range acquisition unit 212, the addition power necessary for near vision B is computed based on an expression of B=1/Nd, and the necessary addition power C based on an expression of C=B−A is further computed. Note that the unit of the accommodation ability data of the eye Amax, the used accommodation ability for near vision A, the addition power necessary for near vision B, the lens necessary addition power C is diopter (D), and the unit of the near vision prescription range data Nd is meter (m). In the embodiment, in computation, the necessary addition power C is rounded in units of 0.25 (D). For example, regarding the necessary addition power C, the computed value is not used as it is, but rounded in units of 0.25 (D) such as 1.0 (D), 1.25 (D), 1.50 (D), or 1.75 (D) by rounding off or the like.

The range computation unit 233 computes the maximum distance ranges Dmax and the maximum near ranges Nmax when lenses are worn based on the necessary addition power C in types of lenses, for example, type 1, type 2, type 3 selected by a selecting unit, which will be described later, as lenses having design elements of the set condition equal to or more than the necessary addition power C computed in the necessary addition power computation unit 232 of the plural types stored in the lens database 221. That is, the maximum distance range Dmax when the lens is worn is computed from an expression of Dmax=1/(B−C), and the maximum near range Nmax is obtained from an expression of Nmax=1/(B+C) with respect to each of the selected types from the loaded design parameter. Note that the accommodation ability of the wearer may be used in place of the necessary addition power for near vision B. Here, the unit of the maximum distance range Dmax and the maximum near range Nmax is meter (m).

The line-of-sight position addition power computation unit 234 computes addition power F in the line-of-sight position based on the line-of-sight position data acquired in the line-of-sight position acquisition unit 213.

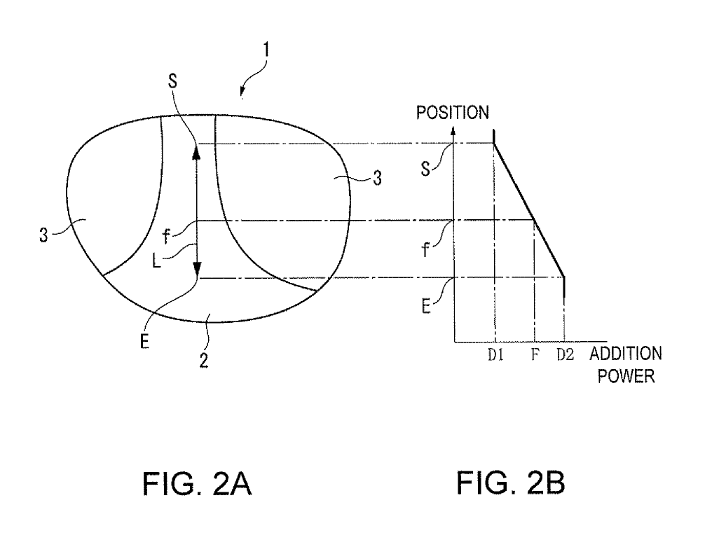

FIGS. 2A and 2B show a relationship between the line-of-sight position and the addition power. FIG. 2A is a front view of the progressive-power lens, and FIG. 2B is a graph showing the position on the lens where the line of sight L frequently passes when the lens is worn and a change of power in the position.

In FIG. 2A, a progressive-power lens 1 includes a near portion 2 having power corresponding to near vision, and both sides of the near portion 2 are side parts 3.

In the progressive-power lens 1, the virtual line segment L that the line of sight frequently passes when the lens is worn is provided on the lens. It is preferable that the line segment L is the principal meridian of the progressive-power lens 1.

Of the line segment L that the line of sight passes, the upper position is set to a progressive start point S and the lower position of the line segment L is set to a progressive end point E. The addition power continuously changes between the progressive start point S and the progressive end point E.

As shown in FIG. 2B, on the line segment L, regarding the dioptric power (power), the dioptric power at the progressive start point S is dioptric power D1, the dioptric power continuously increases from D1 to D2 from the progressive start point S to the progressive end point E, and the dioptric power at the progressive end point E is D2.

In the embodiment, when the position of the line-of-sight position f between the progressive start point S and the progressive end point E is known, the addition power F (D) in the position is obtained based on the graph in FIG. 2B.

In FIG. 1, the distance range computation unit 235 computes a distance range Dm in the line-of-sight position f based on the addition power F in the line-of-sight position f computed in the line-of-sight position addition power computation unit 234 according to an expression of D=1/F.

The selecting unit 24 selects plural types, for example, type 1, type 2, type 3 having design elements of the set condition equal to or more than the necessary addition power C computed in the necessary addition power computation unit 232 of the design parameters with respect to each addition power stored in the lens database 221.

The determination unit 25 compares the working range W acquired in the working range acquisition unit 214 with the distance range (Dm) computed in the distance range computation unit 235, and determines that clear vision may be obtained in the working range if W<Dm or determines that clear vision may not be obtained in the working range if W>Dm.

The output control unit 26 controls the display device 30 to display the maximum distance ranges Dmax and the maximum near ranges Nmax in juxtaposition in graphic representation with respect to each of the selected design types, for example, type 1, type 2, type 3, and further adds “OK” or “NG” as a determination result with respect to each of type 1, type 2, type 3.

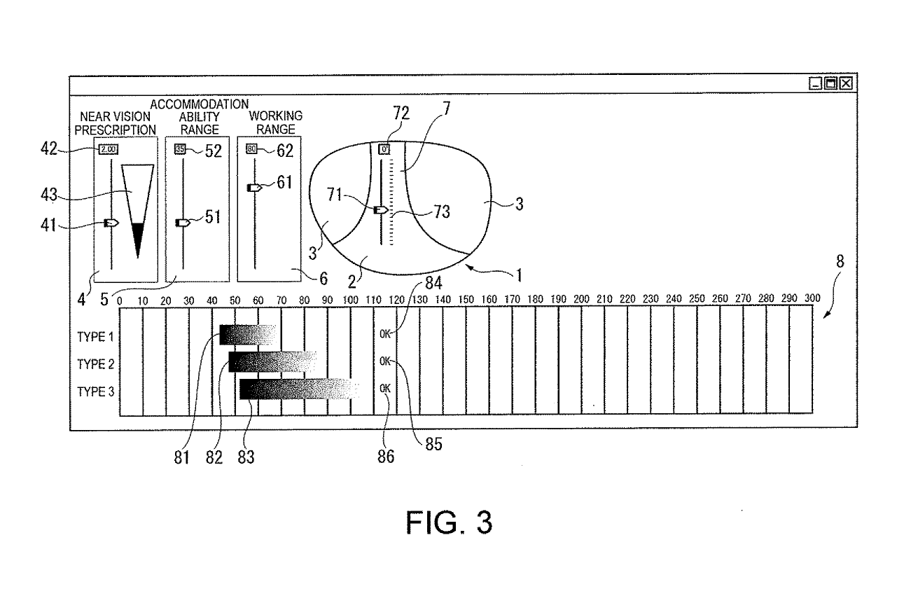

FIG. 3 shows a screen displayed in the display device 30.

In FIG. 3, in the screen of the display device 30, an input window for accommodation ability 4, an input window for near prescription range 5, an input window for working range 6, an input window for line-of-sight position 7, and a graph part for clear vision ranges 8 shown with respect to each type are respectively provided. The numeric values are input to the windows through the input device 10.

The input window for accommodation ability 4 includes a lever 41 vertically movable for inputting accommodation ability data, a numeric value display part 42 that displays the numeric value of the accommodation ability input by the lever 41, and a graph part 43 that displays a ratio of the input numeric value to the maximum value.

The input window for near prescription range 5 includes a lever 51 vertically movable for inputting near prescription range data, and a numeric value display part 52 that displays the numeric value of the near prescription range input by the lever 51.

The input window for working range 6 includes a lever 61 vertically movable for inputting working range data, and a numeric value display part 62 that displays the numeric value of the working range input by the lever 61.

The input window for line-of-sight position 7 is provided in the schematic diagram of the progressive-power lens 1, and includes a lever 71 vertically movable for inputting line-of-sight position data, a numeric value display part 72 that displays the numeric value of the line-of-sight position input by the lever 71, and a scale part 73 displayed along the lever 71.

In the graph part for clear vision ranges 8, the horizontal axis indicates a range, and the clear ranges in type 1, type 2, type 3 are shown as bar parts 81, 82, 83. Of the bar parts 81, 82, 83, the left end numeric value shows the maximum near range Nmax and the right end numeric value shows the maximum distance range Dmax.

The right end sides of the bar parts 81, 82, 83 are gradationally displayed.

In the graph part 8, determination display parts 84, 85, 86 showing determination results for respective types are shown. In FIG. 3, determination of “OK” is shown for all of the three types.

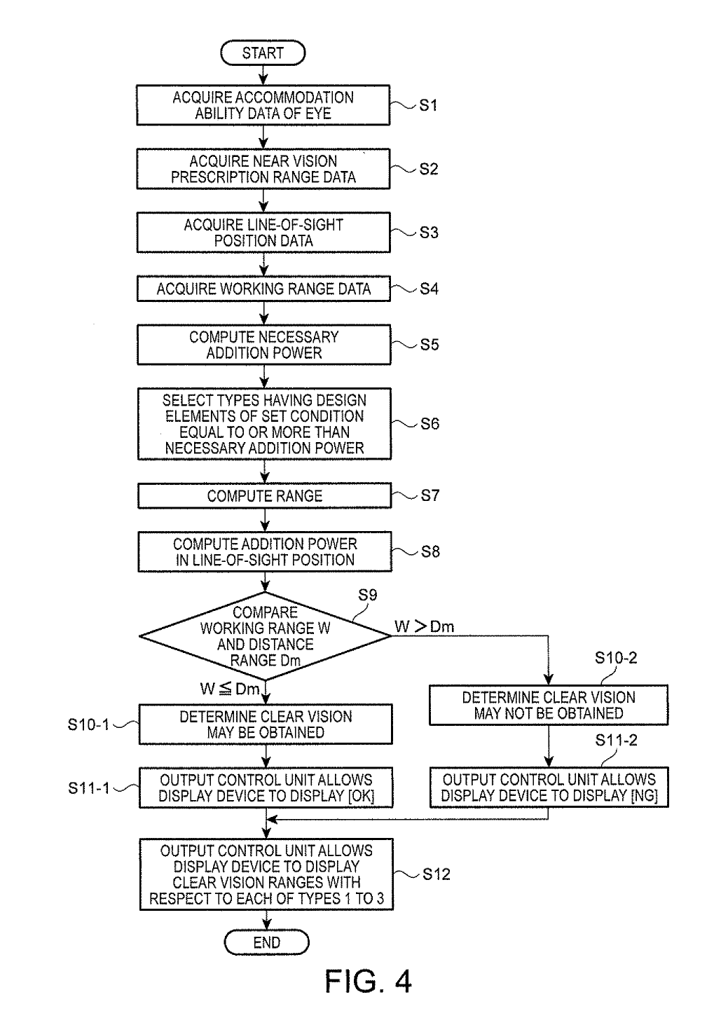

Next, a selection method of the progressive-power lens according to the embodiment will be explained with reference to FIG. 4. FIG. 4 is a flowchart for explanation of the selection method.

In FIG. 4, the accommodation ability acquisition unit 211 acquires the accommodation ability data of the eye (S1), the near vision prescription range acquisition unit 212 acquires the near vision prescription range data (S2), the line-of-sight position acquisition unit 213 acquires the line-of-sight position data (S3), and the working range acquisition unit 214 acquires the working range data (S4).

These steps S1 to S4 are acquisition procedures and the order from S1 to S4 is not fixed in the embodiment. To perform the data acquisition procedures, it is necessary that data is input through the screen of the display device 30.

Then, a necessary addition power computation procedure of computing the necessary addition power for near vision based on the near vision prescription range data is performed (S5).

Further, a selection procedure of selecting types 1 to 3 having design elements of the set condition equal to or more than the necessary addition power computed in the necessary addition power computation procedure from the lens database 221 in which the design parameters of the progressive-power lens are stored with respect to each of the plural types in response to addition power is performed (S6).

A range computation procedure of computing the maximum distance ranges and the maximum near ranges when the lenses are worn is performed based on the computation results of the necessary addition power computed in the necessary addition power computation procedure (S7).

A line-of-sight position addition power computation procedure of computing the addition power in the line-of-sight position is performed from the line-of-sight position data acquired in the line-of-sight position acquisition unit 213 and the design parameters loaded in the selection procedure (S8).

Whether the distance range Dm in the line-of-sight position is equal or more than the working range W (W≦Dm) or the distance range Dm in the line-of-sight position is less than the working range W (W>Dm) is determined (S9), if W≦Dm, determination that clear vision may be obtained in the working range is made (S10-1), and, if the distance range Dm in the line-of-sight position is less than the working range W (W>Dm), determination that clear vision may not be obtained in the working range is made (S10-2). If the determination that clear vision may be obtained in the working range is made, the output control unit 26 allows the display device 30 to display “OK” (S11-1) and, if the determination that clear vision may not be obtained is made, the output control unit allows the display device 30 to display “NG” (S11-2). Further, the output control unit 26 allows the display device 30 to display the maximum distance range and the maximum near range computed in the range computation procedure in juxtaposition with respect to each of the selected design types (S12).

Therefore, in the embodiment, there are the following advantages.

(1) Since the selector includes the accommodation ability acquisition unit 211 that acquires the accommodation ability data of the eye of the wearer, the near vision prescription range acquisition unit 212 that acquires the near vision prescription range data, the lens database 221 in which the design parameters of the progressive-power lens corresponding to the addition power are stored in response to addition power with respect to each of plural types, the accommodation ability computation unit 231 that computes the used accommodation ability for near vision based on the accommodation ability data of the eye acquired in the accommodation ability acquisition unit 211, the necessary addition power computation unit 232 that computes the necessary addition power for near vision based on the near vision prescription range data acquired in the near vision prescription range acquisition unit 212, the range computation unit 233 that computes the maximum distance ranges and the maximum near ranges when lenses are worn in lenses selected as lenses having design elements of the set condition equal to or more than the necessary addition power computed in the necessary addition power computation unit 232 of the plural types stored in the lens database 221, and the output control unit 26 that controls the display device 30 to display the maximum distance ranges and the maximum near ranges computed in the range computation unit 233 in juxtaposition with respect to the lenses of the design types selected by the selecting unit 24, the clear vision ranges of the lenses of the plural types are displayed in juxtaposition and the selection operation of the progressive-power lens from the plural types may be easily performed.

(2) Since the line-of-sight position acquisition unit 213 that acquires the data of the line-of-sight position, the working range acquisition unit 214 that acquires the data of the working range of the wearer, the line-of-sight position addition power computation unit 234 that computes addition power in the line-of-sight position based on the data of the line-of-sight position acquired in the line-of-sight position acquisition unit 213, the distance range computation unit 235 that computes the distance range in the line-of-sight position based on the addition power in the line-of-sight position computed in the line-of-sight position addition power computation unit 234, and the determination unit 25 that determines whether or not the distance range in the line-of-sight position computed in the distance range computation unit 235 falls within the range of the data of the working range acquired in the working range acquisition unit 214 are provided and the output control unit 26 allows the display device 30 to display “OK” and “NG” as results determined in the determination unit 25, the determination results that the clear vision may or may not be obtained in the working range are displayed on the display device 30, and the depth clear vision range in the line-of-sight position may be appropriately determined. Therefore, the best of the plural, progressive-power lenses for the wearer to see may be more easily selected.

(3) Since the use rate database 222 that stores accommodation ability use rates ap for near vision is provided and the accommodation ability computation unit 231 computes the used accommodation ability for near vision A by multiplying the accommodation ability data of the eye Amax acquired in the accommodation ability acquisition unit 211 by the accommodation ability use rate ap stored in the use rate database 222, the used accommodation ability is obtained in consideration of the use condition of the accommodation ability for near vision, and the progressive-power lens may be more properly selected.

(4) The output control unit 26 allows the display device 30 to display the maximum distance ranges and the maximum near ranges in graphic representation. That is, the clear vision ranges are displayed in graphic representation respectively in the plural types of lenses, and thus, the selection operation of the progressive-power lens may be more easily performed.

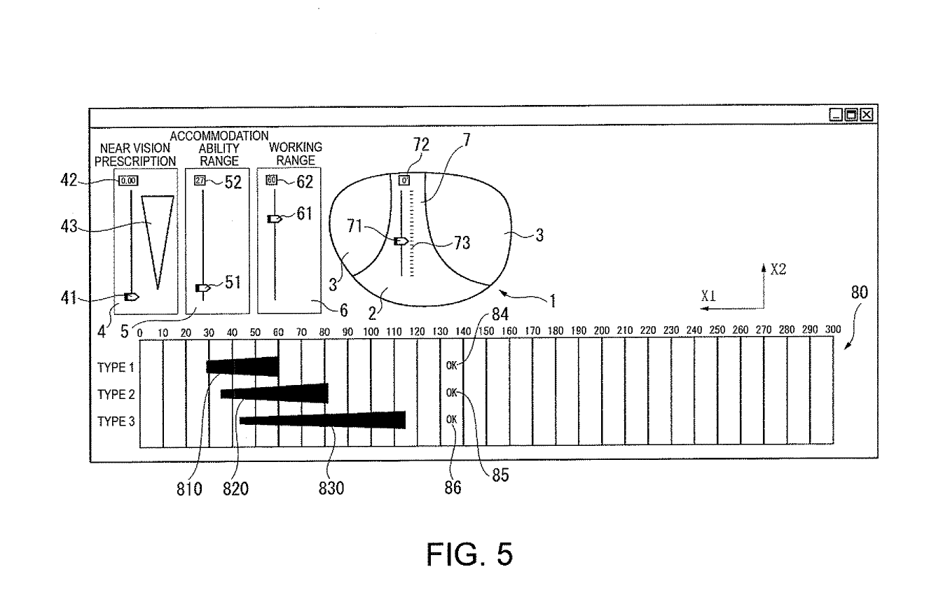

Next, a second embodiment of the invention will be explained with reference to FIG. 5.

The second embodiment is the same as the first embodiment except that, when the clear vision ranges are displayed with respect to each type of the selected lenses, the widths of the clear vision ranges in the line-of-sight position are also displayed.

The output control unit 26 allows the display device 30 to display positions of the maximum distance ranges and the maximum near ranges as an axis X1 in one direction (first axis) and horizontal widths of the clear vision ranges in the line-of-sight position as an axis X2 orthogonal to the axis X1 in the one direction (second axis). Note that, in the embodiment, the data of the width dimensions of the clear vision ranges have been stored as one of the design parameter in the lens data base 211. The line-of-sight position, the width dimension of the clear vision range, and the distance from the eye are unambiguously determined, and, if the relations between them are recorded in the lens database 221 in advance, the width dimension of the clear vision range and the distance from the eye are determined by setting the line-of-sight position.

FIG. 5 is a similar diagram to FIG. 3 of the first embodiment.

In FIG. 5, a graph part for clear vision ranges 80 includes bar parts 810, 820, 830 in type 1, type 2, type 3, the dimension of the clear vision range in the width direction is larger as the distance of the clear vision range is larger in the bar parts 810, 820, 830, and they are displayed to spread out toward the ends.

Therefore, in the second embodiment, there are the same advantages as (1) to (4) of the first embodiment, and there is the following advantage.

(5) Since the output control unit 26 allows the display device 30 to display the positions of the maximum distance ranges and the maximum near ranges as the axis in one direction and the horizontal widths of the clear vision ranges in the line-of-sight position as the axis orthogonal to the axis in the one direction, the widths of the clear vision ranges are also displayed and the differences in vision when the lenses are used become more specific and the lens selection operation becomes easier.

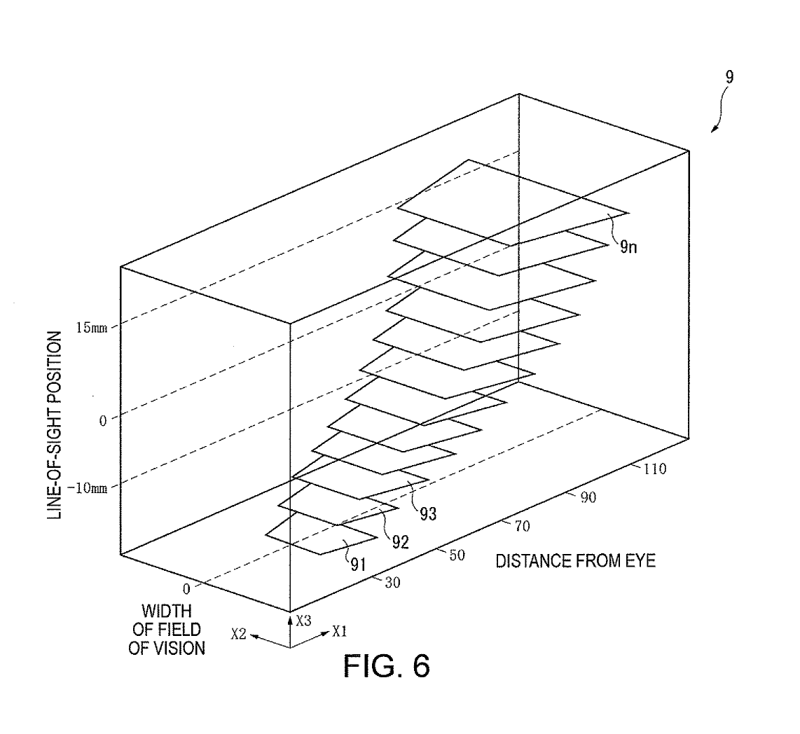

Next, a third embodiment of the invention will be explained with reference to FIG. 6.

The third embodiment is the same as the first embodiment except that the clear vision ranges (in the depth direction) and clear vision field widths (in the horizontal direction) in the respective line-of-sight positions when the line of sight is moved from the distance point to the near point are associated and displayed.

In the embodiment, the output control unit 26 allows the display device 30 to display the line-of-sight position along an axis (third axis) orthogonal to an axis (first axis) for displaying the depth of the clear vision range and an axis (second axis) for displaying the horizontal width of the clear vision range.

FIG. 6 shows a display part 9 of the clear vision ranges. The display part 9 is displayed in a part of the screen of the display device 30 of the first embodiment shown in FIG. 3.

The display part 9 shows the distances from the eye along the axis X1, shows the horizontal widths of the clear vision ranges along the axis X2 orthogonal to the axis X1, and shows the line-of-sight position along the axis X3 orthogonal to the axes X1, X2. As described above, the line-of-sight position, the width dimension of the clear vision range, and the distance from the eye are unambiguously determined, and graphs 91, 92, 93, . . . , 9n corresponding to the line-of-sight positions with respect to each predetermined pitch may be displayed.

Also, in the embodiment, the relations between the line-of-sight position, the width dimension of the clear vision range, and the distance from the eye are recorded in the lens database 221 in advance. Thereby, the width dimension of the clear vision range and the distance from the eye are determined by setting the line-of-sight position.

Therefore, in the third embodiment, there are the same advantages as (1) to (4) of the first embodiment, and there is the following advantage.

(6) Since the output control unit 26 allows the display device 30 to display the line-of-sight position along the axis orthogonal to the axis for displaying the depth of the clear vision range and the axis for displaying the horizontal width of the clear vision range, the clear vision ranges are three-dimensionally displayed with respect to each different line-of-sight position, and the lens selection operation becomes easier.

Note that the invention is not limited to the above described one embodiment, but includes the following modifications within the range in which the purpose of the invention may be achieved.

For example, in the embodiment, the line-of-sight position acquisition unit 213, the working range acquisition unit 214, the line-of-sight position addition power computation unit 234, the distance range computation unit 235, and the determination unit 25 have been provided and the results determined in the determination unit 25 have been displayed in the display device 30, however, in the invention, the configuration of the determination unit 25 etc. may be omitted as long as the maximum distance ranges and the maximum near ranges computed in the range computation unit 233 and the clear vision ranges of the lenses of the design types selected in the selecting unit 24 are displayed in juxtaposition in the display device 30.

Further, in the invention, the output control unit 26 is not limited to the unit which allows the display device 30 to display the maximum distance ranges and the maximum near ranges in graphic representation, but may be a unit of displaying numeric values of the maximum distance ranges and the maximum near ranges with respect to each of the plural types in juxtaposition.

What is claimed is:

1. A progressive-power lens selector, comprising:
an accommodation ability acquisition unit that acquires accommodation ability data as a range that may be clearly seen by an eye of a wearer;
a near vision prescription range acquisition unit that acquires near vision prescription range data as a range the wearer desires to clearly see using a near portion of the progressive-power lens;
a storage unit that stores design parameters of the progressive-power lens in response to different addition power with respect to each of plural types;
an accommodation ability computation unit that computes used accommodation ability for near vision based on the accommodation ability data;
a necessary addition power computation unit that computes necessary addition power for near vision based on the near vision prescription range data;
a range computation unit that selects types having addition power equal to or more than the necessary addition power of the plural types stored in the storage unit and computes the maximum distance ranges and the maximum near ranges when the lenses of the selected types are worn based on the necessary addition power; and
an output control unit that allows a display device to display clear vision ranges with respect to each lens of the selected types in juxtaposition based on the maximum distance ranges and the maximum near ranges.

2. The progressive-power lens selector according to claim 1, further comprising:
a line-of-sight position acquisition unit that acquires data of a line-of-sight position of the wearer in the progressive-power lens;
a working range acquisition unit that acquires data of a working range of the wearer;
a line-of-sight position addition power computation unit that computes addition power in the line-of-sight position based on the data of the line-of-sight position;
a distance range computation unit that computes a distance range in the line-of-sight position based on the addition power in the line-of-sight position; and
a determination unit that determines whether or not the distance range in the line-of-sight position falls within a range of the data of the working range,
wherein the output control unit allows the display device to display a result determined in the determination unit.

3. The progressive-power lens selector according to claim 1, wherein the storage unit stores accommodation ability use rates for near vision, and
the accommodation ability computation unit computes the used accommodation ability for near vision by multiplying the data of the accommodation ability by the accommodation ability use rate.

4. The progressive-power lens selector according to claim 1, wherein the output control unit allows the display device to display the maximum distance ranges and the maximum near ranges in graphic representation.

5. The progressive-power lens selector according to claim 4, wherein the output control unit allows the display device to display a distance in a depth direction of the clear vision range as a first axis and a width of the clear vision range in the line-of-sight position as a second axis orthogonal to the first axis.

6. The progressive-power lens selector according to claim 5, wherein the output control unit allows the display device to display the line-of-sight position along a third axis orthogonal to the first axis and orthogonal to the second axis.

7. A progressive-power lens selection method, comprising:
acquiring accommodation ability data as a range that may be clearly seen by an eye of a wearer;
acquiring near vision prescription range data as a range the wearer desires to clearly see using a near portion of the progressive-power lens;
computing used accommodation ability for near vision based on the accommodation ability data;
computing necessary addition power for near vision based on the near vision prescription range data;
selecting types having addition power equal to or more than the necessary addition power from a storage unit that stores design parameters of the progressive-power lens in response to different addition power with respect to each of plural types;
computing the maximum distance ranges and the maximum near ranges when the lenses are worn based on the necessary addition power; and
allowing a display device to display clear vision ranges with respect to each lens of the selected types in juxtaposition based on the maximum distance ranges and the maximum near ranges.

8. A non-transitory computer readable storage medium storing a progressive-power lens selection program, the program allows a computer to realize:
acquiring accommodation ability data as a range that may be clearly seen by an eye of a wearer;
acquiring near vision prescription range data as a range the wearer desires to clearly see using a near portion of the progressive-power lens;
computing used accommodation ability for near vision based on the accommodation ability data;
computing necessary addition power for near vision based on the near vision prescription range data;
selecting types having addition power equal to or more than the necessary addition power from a storage unit that stores design parameters of the progressive-power lens in response to different addition power with respect to each of plural types;
computing the maximum distance ranges and the maximum near ranges when the lenses are worn based on the necessary addition power; and
allowing a display device to display clear vision ranges with respect to each lens of the selected types in juxtaposition based on the maximum distance ranges and the maximum near ranges.
